(19) United States
(12) Patent Application Publication
(10) Pub. No.: US 2025/0069017 A1
(43) Pub. Date: Feb. 27, 2025

(54) RANSOMWARE SIMULATION AND TRAINING PLATFORM

(71) Applicant: Dell Products L.P., Round Rock, TX (US)

(72) Inventors: Parminder Singh Sethi, Punjab (IN); Shelesh Chopra, Bangalore (IN); Srinath Kappgal, Cork (IE); Atishay Jain, Meerut (IN)

(21) Appl. No.: 18/453,695

(22) Filed: Aug. 22, 2023

(51) Int. Cl. G06F 21/57; G06F 21/55

(52) U.S. Cl. CPC G06F 21/577; G06F 21/552; G06F 2221/034

(57) ABSTRACT

A method for providing ransomware training includes conducting a skill assessment for a user to determine a user performance level of the user; determining user attributes associated with the user, and user attributes include a user type, a user role, and a list of providers associated with the user; generating a training exercise including a simulated attack, and generating the simulated attack includes identifying a real-world ransomware attack, determining attack attributes of the real-world ransomware attack, and generating the simulated attack based on the attack attributes, the user attributes, and the user performance level; conducting the training exercise by sending the simulated attack to the user; receiving an attack response from the user, where the attack response includes the user's response to the simulated attack; and providing feedback to the user based on the attack response, the user attributes, and the user performance level.

### BACKGROUND

Computing devices may provide services. To provide the services, the computing devices may include hardware components and software components. The software components may store information usable to provide the services using the hardware components. From time-to-time, data may be migrated from one device to another device. Such migrating may present an opportunity for a bad actor to perform inappropriate actions on the data being migrated.

### SUMMARY

In general, embodiments described herein relate to a method for providing ransomware training, the method includes conducting a skill assessment for a user to determine a user performance level of the user. The method further includes determining user attributes associated with the user, and user attributes include a user type, a user role, and a list of providers associated with the user. The method also includes generating a training exercise that includes a simulated attack, and generating the simulated attack includes identifying a real-world ransomware attack, determining attack attributes of the real-world ransomware attack, where the attack attributes include a target user type, a type of attack, and a level of attack, and generating the simulated attack based on the attack attributes, the user attributes, and the user performance level. In addition, the method includes conducting the training exercise by sending the simulated attack to the user. Moreover, the method includes receiving an attack response from the user, where the attack response includes the user's response to the simulated attack. Further, the method includes providing feedback to the user based on the attack response, the user attributes, and the user performance level.

In general, embodiments described herein relate to a method for performing a providing a ransom training exercise, the method includes identifying a real-world ransomware attack and determining attack attributes of the real-world ransomware attack, where the attack attributes include a target user type, a type of attack, and a level of attack. The method also includes determining organization attributes of an organization, that include types of users, roles of users, an organizational list of providers, communication formats, or user performance levels. The method further includes generating a simulated attack based on the attack attributes and the organization attributes. In addition, the method includes determining multiple sets of user attributes, where each set of user attributes is associated with a user of multiple users associated with the organization, and each set of user attributes includes a user type, a user role, and a user list of providers. Moreover, the method includes selecting a portion of the users based on the simulated attack and the sets of user attributes. Further, the method includes sending the simulated attack to each user of the portion of the plurality of users.

In general, embodiments described herein relate to a non-transitory computer readable medium including computer readable program code, which when executed by a computer processor enables the computer processor to perform a method for providing a ransomware training exercise, the method includes identifying a real-world ransomware attack and determining attack attributes of the real-world ransomware attack, where the attack attributes include a target user type, a type of attack, and a level of attack. The method also includes determining organization attributes of an organization, that include types of users, roles of users, an organizational list of providers, communication formats, or user performance levels. The method further includes generating a simulated attack based on the attack attributes and the organization attributes. In addition, the method includes determining multiple sets of user attributes, where each set of user attributes is associated with a user of multiple users associated with the organization, and each set of user attributes includes a user type, a user role, and a user list of providers. Moreover, the method includes selecting a portion of the users based on the simulated attack and the sets of user attributes. Further, the method includes sending the simulated attack to each user of the portion of the plurality of users. Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example, and are not meant to limit the scope of the claims.

FIG. 1 shows a diagram of a system in accordance with one or more embodiments.

FIG. 2 shows a diagram of a training agent in accordance with one or more embodiments.

FIG. 3 shows a method for providing a ransomware training in accordance with one or more embodiments.

FIG. 4 shows a method for providing a simulated attack exercise in accordance with one or more embodiments.

FIG. 5 shows a method for generating simulated attacks in accordance with one or more embodiments.

FIG. 6 shows a diagram of a computing device in accordance with one or more embodiments.

### DETAILED DESCRIPTION

In the below description, numerous details are set forth as examples of embodiments described herein. It will be understood by those skilled in the art, and having the benefit of this Detailed Description, that one or more embodiments described herein may be practiced without these specific details, and that numerous variations or modifications may be possible without departing from the scope of the embodiments described herein. Certain details known to those of ordinary skill in the art may be omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, embodiments described herein relate to methods, systems and non-transitory computer readable mediums storing instructions for creating and executing ransomware training operations. In one or more embodiments, a ransomware training platform may be provided as a cloud-based service that is stored in a server module (i.e., a cloud-based server) and provides the training platform over a network to one or more client devices. Doing so enables the ransomware training platform to be accessible from any device while also providing an all-in-one platform that is more easily manageable by a user that is managing training of members of an organization.

The training platform may include realistic simulations, training modules, personalized feedback, integration with existing tools, gamification elements, monitoring of user progress, and analytics of user performance. In one or more embodiments, the realistic simulations include phishing emails and social engineering tactics based on real-world activities by bad actors. In one or more embodiments, the training modules include a library of training resources that users may access at any time and from different devices. In one or more embodiments, the personalized feedback provides areas in which a user can improve and further provides suggestions for further training that may inform a user how to improve. In one or more embodiments, the training platform integrates with an existing security information and event management system to provide a broader view of an organization's data safety posture. In one or more embodiments, the training platform incorporates gamification elements in which users may earn points, badges, and/or other rewards, which may be viewable and comparable to other users to provide competition and progress goals to users to drive further engagement of the users. In one or more embodiments, the training platform provides monitoring tools that monitor each user's progress that may be viewable by an administrator of the training platform to enable the administrator to ensure that each user is following the appropriate progress. In one or more embodiments, the training platform provides analytics of user performance that aggregates all of the user's performance to enable an administrator to identify how the user base is generally performing. Each of the above implementations enhances the ransomware training provided to users.

The following describes various embodiments of the invention.

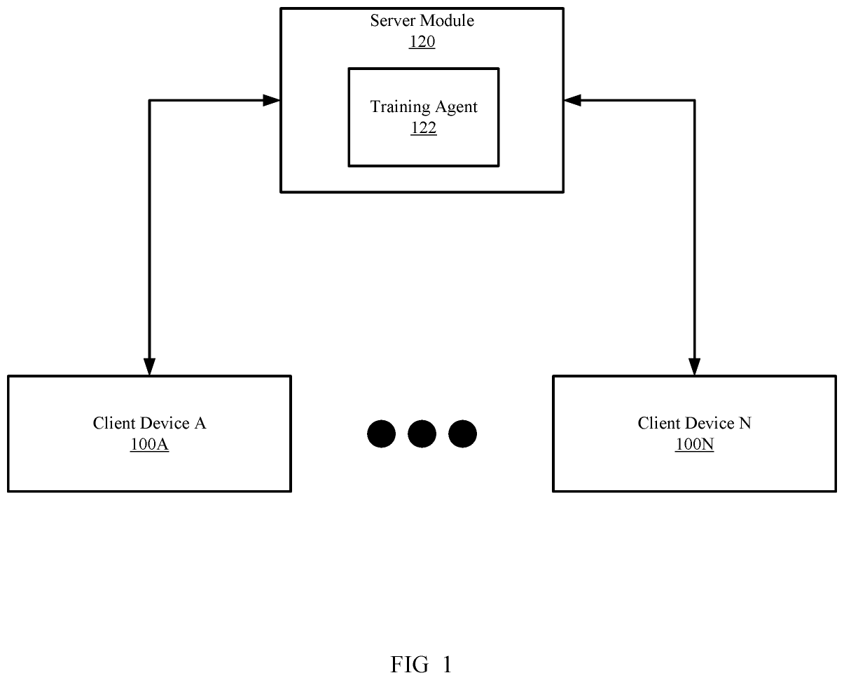

FIG. 1 shows a diagram of a system in accordance with one or more embodiments described herein. The system may include any number of client device(s) (e.g., 100A-100N) and any number of server module(s) (120). In one or more embodiments, the server module (120) includes a training agent (122). Each of these components is described below.

In one or more embodiments, the server module (120) is one or more data centers that are each configured for hosting and maintaining various workloads (such as the training agent (122)), and/or for providing a computing environment (e.g., computing power and storage) whereon workloads may be implemented. In general, a data center's (e.g., a site's, a node's, etc.) infrastructure is based on a network of computing and storage resources that enable the delivery of shared applications and data. For example, a data center of an organization may exchange data with other data centers of the same organization registered in/to the network in order to, for example, participate in a collaborative workload placement, which may be accomplished by migrating applications from one data center to another. One of ordinary skill will appreciate that a data center may perform other functionalities without departing from the scope of the invention.

In one or more embodiments, the client device(s) (e.g., 100A-100N) may be computing devices. Such computing devices may be referred to as endpoints. In one or more embodiments, an endpoint is any computing device, collection of computing devices, portion of one or more computing devices, or any other logical grouping of computing resources. In one or more embodiments, the client device(s) (e.g., 100A-100N) may collectively be referred to as a client environment.

In one or more embodiments, a computing device is any device, portion of a device, or any set of devices capable of electronically processing instructions and may include, but is not limited to, any of the following: one or more processors (e.g. components that include integrated circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown) and/or any combination thereof.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer and/or any other mobile computing device), a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), and/or any other type of computing device with the aforementioned requirements. In one or more embodiments, any or all of the aforementioned examples may be combined to create a system of such devices, which may collectively be referred to as a computing device. Other types of computing devices may be used without departing from the scope of the invention. In one or more embodiments, a set of computing devices may form all or a portion of a data domain, all, or part of which may require migrating from time to time (e.g., upon request and/or pursuant to a defined schedule). In one or more embodiments, a data domain is any set of computing devices for which data migration operations are performed.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, a computing device includes and/or is operatively connected to any number of storage volumes (not shown). In one or more embodiments, a volume is a logically accessible storage element of a computing system. A volume may be part of one or more disk drives, and may or may not include any number of partitions. In one or more embodiments, a volume stores information relevant to the operation and/or accessible data of a computing device. In one or more embodiments, a volume may be all or part of any type of computing device storage (described above).

In one or more embodiments, any non-volatile storage (not shown) and/or memory (not shown) of a computing device or system of computing devices may be considered, in whole or in part, as non-transitory computer readable mediums storing software and/or firmware.

Such software and/or firmware may include instructions which, when executed by the one or more processors (not shown) or other hardware (e.g., circuitry) of a computing device and/or system of computing devices, cause the one or more processors and/or other hardware components to perform operations in accordance with one or more embodiments described herein.

The software instructions may be in the form of computer readable program code to perform methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

In one or more embodiments, the system also includes the training agent (122). In one or more embodiments, the training agent (122) is operatively connected to one or more of the client device(s) (e.g., 100A-100N). In one or more embodiments, the training agent (122) may be implemented as a logical device. The logical device may utilize the computing resources of any number of computing devices to provide the functionality of the data center described throughout this application.

In one or more embodiments, the client device(s) (e.g., 100A-100N) and the server module (120) are operatively connected via a network (not shown). In one or more embodiments, the network may represent a computing network configured for computing resource and/or messages exchange among registered computing hosts (e.g., the client device(s) (e.g., 100A-100N), the server module (120), etc.). As discussed above, components of the system may operatively connect to one another through the network (e.g., a LAN, a WAN, a mobile network, a wireless LAN (WLAN), etc.). In one or more embodiments, the network may be implemented using any combination of wired and/or wireless network topologies, and the network may be operably connected to the Internet or other networks. Further, the network may enable interactions between the client device(s) (e.g., 100A-100N) and the server module (120) through any number and types of wired and/or wireless network protocols (e.g., TCP, UDP, Internet Protocol version 4 (IPv4), etc.).

While FIG. 1 shows a configuration of components, other configurations may be used without departing from the scope of embodiments described herein. Accordingly, embodiments disclosed herein should not be limited to the configuration of components shown in FIG. 1.

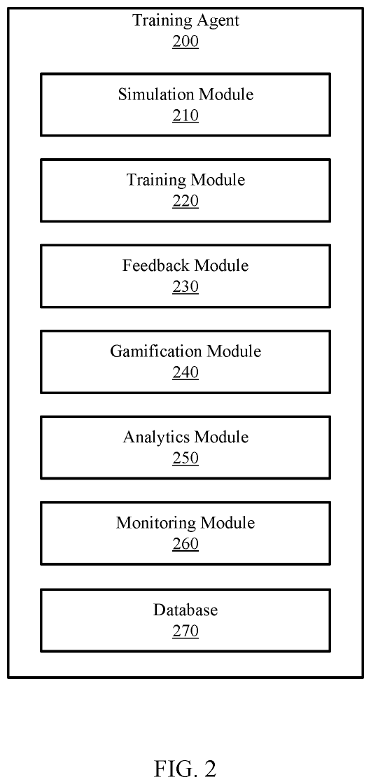

Turning now to FIG. 2, FIG. 2 shows a diagram of a training agent (200) in accordance with one or more embodiments. The training agent (200) is an example of the training agent (e.g., 122) discussed above in reference to FIG. 1. In one or more embodiments, the training agent (200) includes a simulation module (210), a training module (220), a feedback module (230), a gamification module (240), an analytics module (250), a monitoring module (260), and a database (270). The training agent (200) may include additional, fewer, and/or different components without departing from the scope disclosed herein. Each component may be operably connected to any of the other components via any combination of wired and/or wireless connections. Each component may be implemented using a computing device, a logical device, software, hardware, or any combination thereof. Each component illustrated in FIG. 2 is discussed below.

In one or more embodiments, the simulation module (210) includes functionality to generate simulations of attacks (e.g., ransomware, phishing, social engineering, or any other attack utilized by a bad actor that poses a data and/or cybersecurity risk). In one or more embodiments, the simulation module (210) receives one or more real-world attacks that were actually used by a bad actor and generates simulated attacks based on the one or more real-world attacks. In addition, in one or more embodiments, the simulation module (210) continues to receive real-world attacks and can generate new simulated attacks and/or modify existing simulated attacks based on the newly received real-world attacks.

In one or more embodiments, the simulation module (210) includes functionality to enable a user to manually generate and/or update simulated attacks. In one or more embodiments, the simulation module (210) includes functionality to automatically generate and/or update simulated attacks. For example, the simulation module (210) may include a learning model (e.g., a supervised model, an unsupervised model, a neural network with any number of layers and/or nodes per layer, generative artificial intelligence, etc.) to receive certain input data and output simulated attacks. In one or more embodiments, the feedback module (210) generates and/or updates the simulated attacks based at least in part on organization attributes, organizational data, user attributes, user performance level, one or more real-world attacks, attack attributes, user feedback, and/or user responses.

In one or more embodiments, the organization attributes includes information about the organization as a whole, including types of users in the organization (e.g., human resources, executives, information technology, legal, support staff, sales, or any other type of job within an organization), roles of users in the organization (e.g., handling personal information, handling financial information, control over secure systems, or any other role within an organization), an organizational list of providers (e.g., names of third-parties with whom members of the organization communicate), communication formats (e.g., phone call, email, text message, syntax of messages, lexicology used in messages, or any other details used in communicating with others, either between members of the organization and/or members of the organization and third-parties), and/or user performance levels (e.g., the tested performance level of member of the organization, which is described in further detail below).

In one or more embodiments, the organizational data includes a summary of the organization, which may include a grouping of multiple pieces of information within the organization, including user attributes, user performance level, user feedback, and/or user responses. In one or more embodiments, the user attributes includes information about a specific member of an organization, including the user type, role within the organization, a list of providers associated with the user, communication formats associated with the user, and/or a performance level of the user. In one or more embodiments, the attack attributes include information about a specific real-world attack, including a target user type, a type of attack (e.g., phishing, social engineering, etc.), and a level of attack (e.g., a measure of the sophistication of the attack).

In providing the above functionality, the simulated attacks generated by the simulation module (210) offer realistic simulations of attacks and are based on the latest threat intelligence and real-world attacks. Further, the simulated attacks include tactics commonly used by real-world bad actors and provide members of an organization hands-on experience in identifying and responding to threats, thereby enhancing the members' practical skills and awareness of threats. In addition, the above functionality provides simulated attacks that are continuously updated over time, thereby adapting to the changing tactics of bad actors. Moreover, the functionality provides customization on an organization-level and even a user-level to provide accurate testing of members of the organization.

In one or more embodiments, the training module (220) includes functionality to register users, provide training, provide simulated attacks, and assess user's skills. In one or more embodiments, registering users includes receiving user credentials (e.g., personally identifying information, user account information, etc.) to register the user on the platform. A list and/or database of user credentials may initially be provided by an administrator and the training module (220) may reference this list and/or database when registering a user on the platform. In one or more embodiments, the training module (220) also handles ongoing user logins via user authentication mechanisms (e.g., username and password, multi-factor authentication, single sign-on, etc.).

In one or more embodiments, when a user registers for the first time, the training module (220) provides an initial skills assessment to determine a user performance level. The initial skill assessment may include providing a questionnaire, providing a simulated attack, and/or setting the user performance level to a default value. In one or more embodiments, the questionnaire may include questions relating to the user's type and/or role within the organization, testing the user's knowledge of attacks, including questioning how a user would respond to certain scenarios. As such, the questionnaire may provide the user's initial knowledge of threats, attacks and/or cybersecurity awareness.

In one or more embodiments, the training provided by the training module (220) includes training exercises and/or resources to the user, such as videos, text, walkthroughs, guides, and/or any other teaching mechanism to advance the user's knowledge of threats, attacks and/or cybersecurity awareness. Further, the training provided by the training module (220) may be customized for the user based on user attributes, user performance level, user feedback, and/or user responses. Moreover, the training provided by the training module may be customized at an organization-level based on user attributes, user performance level, user feedback, user responses, and/or organization attributes. In one or more embodiments, the customization is provided by the analytics module (250), discussed further below.

In one or more embodiments, the training module (220) provides simulated attacks (e.g., the simulated attacks generated by the simulation module (210)) to users and receives the users' responses to the simulated attacks. As described above, the simulated attacks may be customized at a user-level and/or an organization-level. Further, in one or more embodiments, the training module (220), the simulated attacks may be a multi-step attack with subsequent steps depending on the response received from the user.

The following is a non-limiting example for illustrative purposes only. In this example, a first user and a second user may both receive the same simulated attack that includes the same first step for both the first user and the second user. The first user then provides a first response to the first step and the second user provides a second response, different than the first response, to the first step. In response, the training module (220) then provides a second step to the first user and a third step, different than the second step, to the second user. As such, the training module (220) is capable of providing simulated attacks that continue based on the user responses, thereby enabling different users to receive different experiences even when provided the same simulated attack.

In one or more embodiments, the feedback module (230) includes functionality to receive user inputs and/or derivatives of the user inputs and provide feedback. In one or more embodiments, the user inputs include the responses to the simulated attacks and/or the training exercises. In one or more embodiments, the derivatives of the user inputs include outputs generated by the analytics module (250), as described below. In one or more embodiments, the feedback is based on the user inputs, derivatives of the user inputs, user attributes, and/or the user performance level. In one or more embodiments, the feedback includes the user's strengths, areas for improvement, and/or suggests further training exercises and/or simulated attacks. In one or more embodiments, the feedback module (230) includes functionality to track the user performance over time and may provide the user performance (e.g., by combining multiple areas into a single score, showing each area separately, or any combination thereof) over time to the user, such as in a visual format. As such, a user can easily see how they are performing in their training over time and may even be able to see which areas have improved more than others. In doing so, the feedback module (230) aids a user in tracking their progress and/or focusing their efforts on areas that need improvement, thereby enhancing the effectiveness of the overall training.

In one or more embodiments, the gamification module (240) includes functionality to include gamification elements into the training platform. In one or more embodiments, the gamification elements include game-like elements for each user and may include points, badges, scores, and/or leaderboards. In one or more embodiments, the gamification module (240) updates the gamification elements based on the user inputs, derivatives of the user inputs, user attributes, and/or the user performance level. For example, users may earn points and badges for completing training exercises and/or simulated attacks and scores based on their responses to training exercises and/or simulated attacks. Further, the gamification elements earned by one user may be viewable by another user to provide competitive elements between users, thereby enhancing user motivation to complete more training and perform better during the training.

In one or more embodiments, the analytics module (250) includes functionality to receive inputs that include the user inputs, derivatives of the user inputs, user attributes, the user performance level, and/or organization data to provide customization for one or more of the other modules. In one or more embodiments, the customization includes generating customized training exercises and/or suggestions for simulated attacks for specific users based on one or more of the inputs. In one or more embodiments, the analytics module (250) also receives real-world attacks and/or real-world attack attributes and generates new training exercises and/or suggestions for existing training exercises based on the real-world attacks and/or real-world attack attributes. In one or more embodiments, the analytics module may receive the inputs and generate the organizational data based on one or more of the inputs.

In one or more embodiments, the monitoring module (260) includes functionality to track inputs that include the user inputs, derivatives of the user inputs, user attributes, the user performance level, and/or organization data over time and provide one or more summaries of the inputs in a user interface, such as a graphical user interface on a display. In one or more embodiments, the summaries are provided only to users having a threshold level of access, such as an administrator of an organization. In one or more embodiments, the summaries provide user-level progress over time, organization-level progress over time, and/or may be filtered by user attributes and/or user performance levels. For example, the administrator may filter the summaries to only show users having a user type of human resources. In one or more embodiments, the summaries track user progress, training effectiveness, training outcomes, user engagement, areas of strength, and/or areas in which additional training may be useful. In doing so, the monitoring module (260) enhances management, measurement, and/or reporting of the training platform's success and impact.

In one or more embodiments, the database (270) may be a fully managed, local, and lightweight database (or any logical container such as SQLite database) that acts as a shared storage or memory resource (discussed above) that is functional to store unstructured and/or structured data. Further, the database (270) may also occupy a portion of a physical storage/memory device or, alternatively, may span across multiple physical storage/memory devices.

In one or more embodiments, the database (270) may be implemented using physical devices that provide data storage services (e.g., storing data and providing copies of previously stored data). The devices that provide data storage services may include hardware devices and/or logical devices. For example, the database (270) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (270) may include a memory device (e.g., a dual in-line memory device), in which data is stored and from which copies of previously stored data are provided. As yet another example, the database (270) may include a persistent storage device (e.g., an SSD), in which data is stored and from which copies of previously stored data is provided. As yet another example, the database (270) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database (270) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the database (270) may store (temporarily or permanently) unstructured and/or structured data that may include (or specify), for example (but not limited to): details of user inputs, derivatives of the user inputs, user attributes, the user performance level, organization data, organization attributes, customization generated by the analytics module (250), simulated attacks generated by the simulation module (210), monitoring provided by the monitoring module (260), configuration parameters, etc.

In one or more embodiments, the training agent (200) also includes functionality to integrate with existing cybersecurity tools, such as security information and event management systems. In one or more embodiments, integration allows for the exchange of data between the existing tool and the training agent (200) to enable an organization to utilize the training agent (200) alongside existing tools. In one or more embodiments, the training agent (200) includes an application programming interface to integrate with the existing tools.

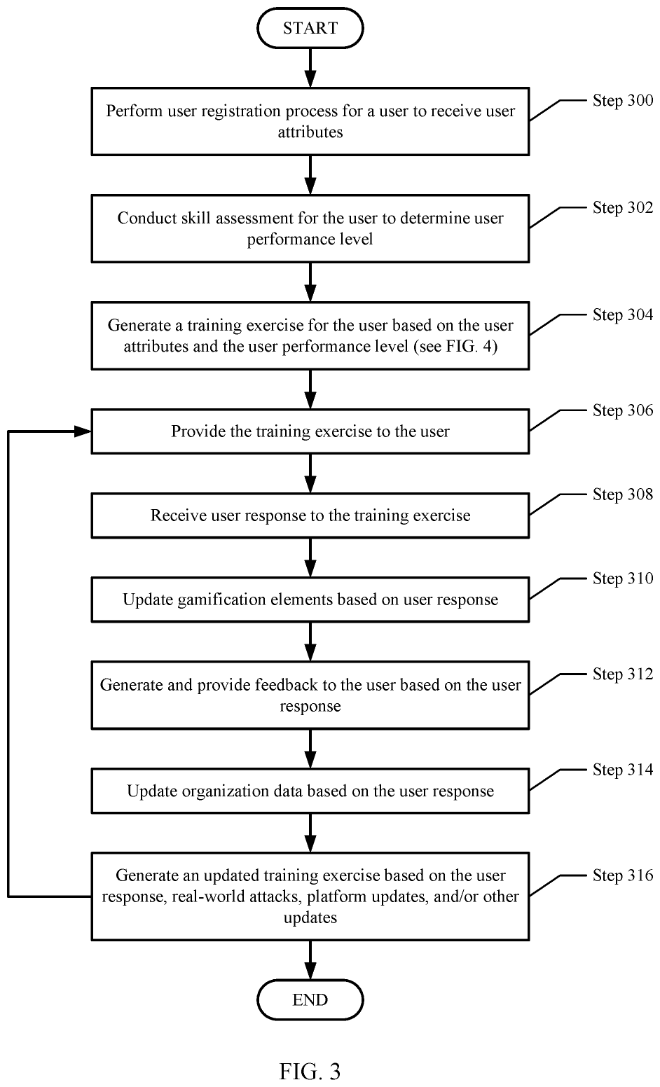

FIG. 3 shows a method for providing cybersecurity (e.g., ransomware) training to a user of an organization in accordance with one or more embodiments. While various steps in the method are presented and described sequentially, those skilled in the art will appreciate that some or all of the steps may be executed in different orders, may be combined or omitted, and some or all steps may be executed in parallel without departing from the scope of the invention.

The method shown in FIG. 3 may provide enhanced cybersecurity training to a user by utilizing real-world based training that is further customized to a specific user. The method further provides steps that enhance user engagement with the training and provide further training to the user that is customized to that user. In addition, the method provides tracking of the user's responses to the training such that the user's progress may be monitored over time and the user's progress may be added to a larger group, such as an organization. Applying the method to many users across an organization provides a view of the organization's preparedness for a cybersecurity event, such as a ransomware attack and track the organization's progress over time.

Turning now to FIG. 3, the method shown in FIG. 3 may be executed by, for example, the above-discussed training agent (e.g., 200, FIG. 2). Other components of the system illustrated in FIG. 1 may also execute all or part of the method shown in FIG. 3 without departing from the scope.

In Step 300, the training agent performs a user registration process for a user to receive user attributes. As described above, the user attributes may include information about a specific member of an organization, including the user type, role within the organization, a list of providers associated with the user, communication formats associated with the user, and/or a performance level of the user. In one or more embodiments, the user registration process also includes receiving user credentials (e.g., personally identifying information, user account information, etc.). In one or more embodiments, the training agent checks the user credentials with a list and/or database of user credentials provided by an administrator.

In Step 302, the training agent conducts a skill assessment for the user to determine the user performance level. In one or more embodiments, the skill assessment includes providing a questionnaire, providing a simulated attack, and/or setting the user performance level to a default value. In one or more embodiments, the questionnaire includes questions relating to the user's type and/or role within the organization, testing the user's knowledge of attacks, including questioning how a user would respond to certain scenarios. As such, the questionnaire may provide the user's initial knowledge of threats, attacks and/or cybersecurity awareness.

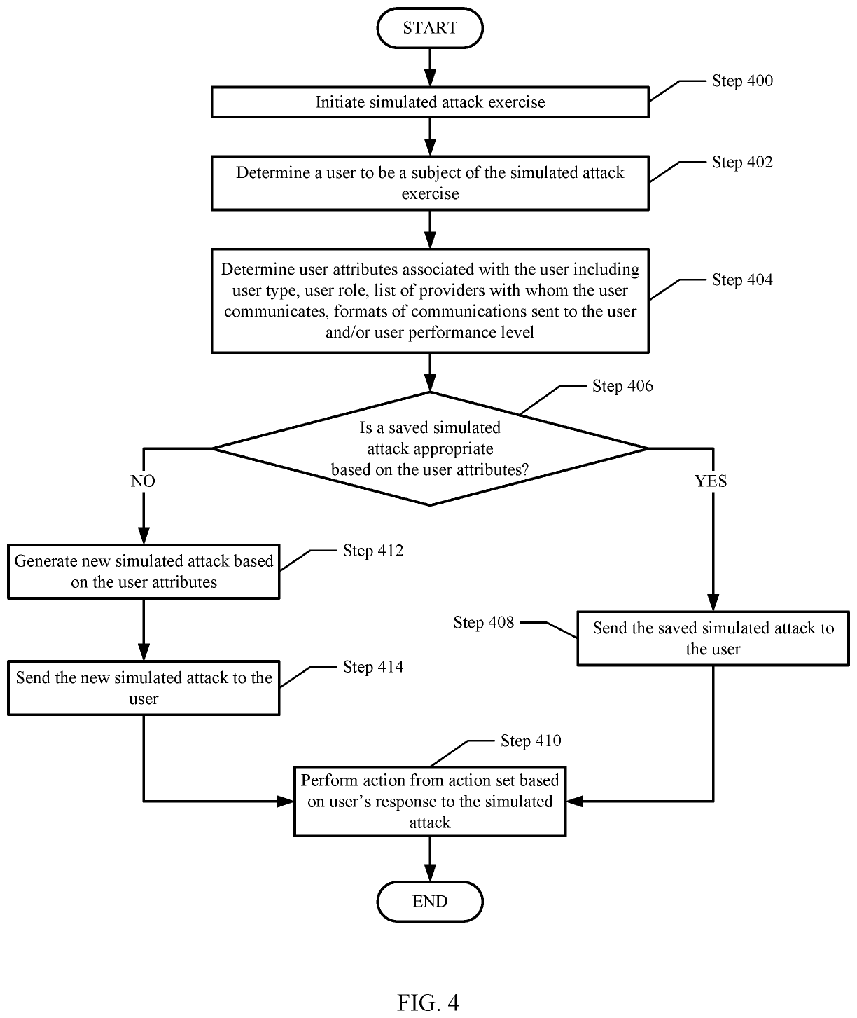

In Step 304, the training agent generates a training exercise for the user based on the user attributes and/or the user performance level. Additional details regarding the performance of Step 304 may be found in the discussion relating to FIG. 4 below.

In Step 306, the training agent provides the training exercise generated in Step 304 to the user. As described above, the training exercise may be a single step operation in which a single step is provided to a user, or the training exercise may be a multi-step exercise in which multiple responses and steps in response to the responses are provided to the user. In either case, the method may continue to the next step.

In Step 308, the training agent receives the user response to the training exercise. In embodiments in which the training exercise is a single step, the training exercise may receive the single response from the user and continue to the next step. In embodiments in which the training exercise includes multiple steps, the training agent may iteratively provide steps of the training exercise and receives response to each step of the training exercise. For example, if the training exercise includes multiple linear steps, the training exercise may provide a step to the user, receive the user's answer to the step and then provide the next step to the user and receive the next response from the user and so on until the training exercise is complete. In one or more embodiments, in multi-step training exercises, which may be considered dynamic, the subsequent steps of the training exercise may depend on the response received from the user.

The following is a non-limiting example for illustrative purposes only. In this example, a first user and a second user may both receive the same training exercise that includes the same first step for both the first user and the second user. The first user then provides a first response to the first step and the second user provides a second response, different than the first response, to the first step. In response, the training agent then provides a second step to the first user and a third step, different than the second step, to the second user. As such, the training agent is capable of providing training exercises that continue based on the user responses, thereby enabling different users to receive different experiences even when provided the same training exercises. In addition, for purposes of clarity, the training exercises may include simulated attacks and/or training resources.

In Step 310, the training agent updates one or more gamification elements based on the user response received in Step 308. In one or more embodiments, the gamification elements include game-like elements for each user and may include points, badges, scores, and/or leaderboards. For example, users may earn points and badges for completing training exercises and scores based on their responses to training exercises. Further, the gamification elements earned by one user may be viewable by another user to provide competitive elements between users.

In Step 312, the training agent generates and provides feedback to the user based on the user response in Step 308. In one or more embodiments, the feedback includes the user's strengths, areas for improvement, and/or suggests further training exercises. In one or more embodiments, the feedback includes a tracking of the user performance over time and may provide the user performance (e.g., by combining multiple areas into a single score, showing each area separately, or any combination thereof) over time to the user, such as in a visual format. As such, a user can easily see how they are performing in their training over time and may even be able to see which areas have improved more than others.

In Step 314, the training agent updates organization data based on the user response received in Step 308. In one or more embodiments, the organizational data includes a summary of the organization, which may include a grouping of multiple pieces of information within the organization, including user attributes, user performance level, user feedback, and/or user responses. In one or more embodiments, the user response updates the organizational data by updating the aggregated data of the organization, which may include multiple users and the data associated with the multiple users. Further, by updating the organization data, the summaries of data provided to, for example, an administrator, is consequently updated.

In one or more embodiments, the updating of the organization data includes determining whether the user response is below a threshold value. For example, if a user's response is indicative of the user failing the exercise, the user response may be considered below a threshold value. If the training agent determines that the user response is below the threshold value, the training agent may display or cause to display an alert to an administrator indicative of the response being below the threshold value along with identifying information of the user. In this manner, the administrator is alerted to the fact that the user failed the training exercise and can make a decision on how to proceed with that user.

In Step 316, the training agent generated an updated training exercise based on the user response from Step 308, one or more real-world attacks, platform updates, and/or other updates. In one or more embodiments, Step 316 generally provides a way to provide to the user updated training exercises that are based on the latest intelligence of threats and/or attacks used against organizations. In one or more embodiments, the real-world attacks include real-world attacks that occur subsequent to the training exercise provided in Step 306. In one or more embodiments, the platform updates include updates made manually by a developer of the platform to capture changes to the threat landscape. In addition, in one or more embodiments the other updates may include user attributes, user performance level, user feedback, user responses, and/or organization attributes, which may capture any changes over time of changes in the user's and/or the organization's changes over time. As such, Step 316 provides a way to continuously update the training provided to the user over time to account for updates to the user and/or updates to bad actor's actions.

In one or more embodiments, the method may end following Step 316.

FIG. 4 shows a method for generating simulated attacks and providing the simulated to users in accordance with one or more embodiments. While various steps in the method are presented and described sequentially, those skilled in the art will appreciate that some or all of the steps may be executed in different orders, may be combined or omitted, and some or all steps may be executed in parallel without departing from the scope of the invention.

The method shown in FIG. 4 may provide enhanced cybersecurity training to a user by selecting simulated attacks based on the user. Thus, the method provides training to the user that is appropriate for that user, thereby enhancing the user's progress in their training and effectively utilizing the user's time.

Turning now to FIG. 4, the method shown in FIG. 4 may be executed by, for example, the above-discussed training agent (e.g., 200, FIG. 2). Other components of the system illustrated in FIG. 1 may also execute all or part of the method shown in FIG. 4 without departing from the scope.

In Step 400, the training agent initiates a simulated attack exercise. The initiation may be based on conducting a skill assessment for a user (e.g., at Step 302, FIG. 3).

In Step 402, the training agent determines a user to be a subject of the simulated attack exercise. The determination of the user may be based on conducting a skill assessment for a user (e.g., at Step 302, FIG. 3), random selection, an interval being reached, a selection by an administrator, etc.

In Step 404, the training agent determines user attributes associated with the user. The user attributes may include user type, user role, list of providers with whom the user communicates, formats of communications sent to the user and/or user performance level, which are each described above. The user attributes may be retrieved from a database (e.g., database (270), FIG. 2).

In Step 406, the training agent determines whether a saved simulated attack is appropriate based on the user attributes. As described above, the training agent is operable to generate simulated attacks and may save the generated simulated attacks. In one or more embodiments, the training agent stores simulated attacks that are generated elsewhere. If the training agent determines that there is a saved simulated attack appropriate for the selected user, then the method proceeds to Step 408. If the training agent determines that there is not a saved simulated attack appropriate for the selected user, then the method proceeds to Step 412.

In Step 408, the training agent sends the saved simulated attack to the user. In one or more embodiments, sending the saved simulated attack to the user is described above with reference to Step 306 and Step 308.

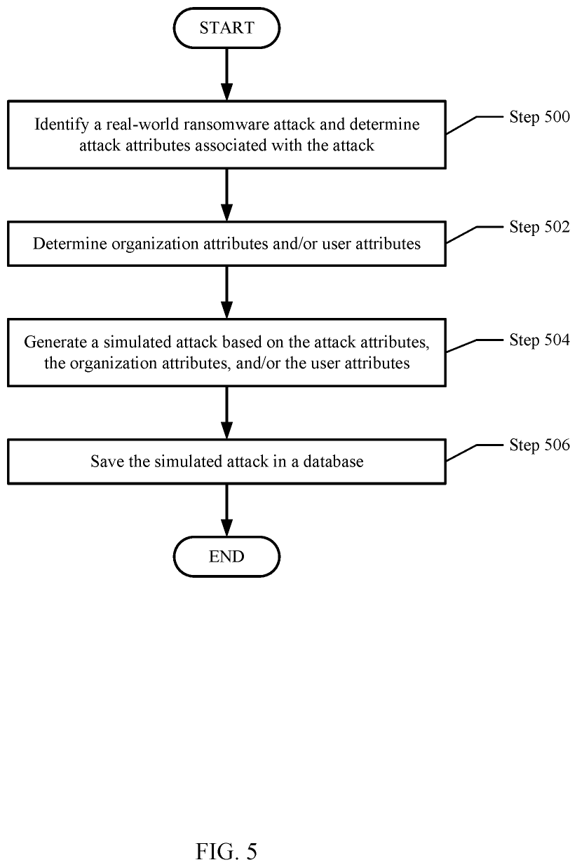

In Step 412, the training agent generates a new simulated attack based on the user attributes. The generation of a new simulated attack is discussed below in reference to FIG. 5.

In Step 414, the training agent sends the new simulated attack to the user. In one or more embodiments, sending the new simulated attack to the user is described above with reference to Step 306 and Step 308.

In Step 410, the training agent performs an action from an action set based on the user's response to the simulated attack. The action set may include any combination of Steps 308, 310, 312, 314, and 316.

The method may end following Step 410.

FIG. 5 shows a method for generating simulated attacks in accordance with one or more embodiments. While various steps in the method are presented and described sequentially, those skilled in the art will appreciate that some or all of the steps may be executed in different orders, may be combined or omitted, and some or all steps may be executed in parallel without departing from the scope of the invention.

The method shown in FIG. 5 may provide enhanced cybersecurity training to a user by generating simulated attacks based on the user and/or organization. The simulated attacks generated by the method offer realistic simulations of attacks and are based on the latest threat intelligence and real-world attacks. Further, the simulated attacks include tactics commonly used by real-world bad actors and provide members of an organization hands-on experience in identifying and responding to threats, thereby enhancing the members' practical skills and awareness of threats. In addition, the above functionality provides simulated attacks that are continuously updated over time, thereby adapting to the changing tactics of bad actors. Moreover, the functionality provides customization on an organization-level and even a user-level to provide accurate testing of members of the organization.

Turning now to FIG. 5, the method shown in FIG. 5 may be executed by, for example, the above-discussed training agent (e.g., 200, FIG. 2). Other components of the system illustrated in FIG. 1 may also execute all or part of the method shown in FIG. 5 without departing from the scope.

In Step 500, the training agent identifies a real-world ransomware attack and determines attack attributes associated with the attack. In one or more embodiments, the attack attributes include information about a specific real-world attack, including a target user type, a type of attack (e.g., phishing, social engineering, etc.), and a level of attack (e.g., a measure of the sophistication of the attack). In one or more embodiments, an administrator provides the real-world ransomware attack to the training agent.

In Step 502, the training agent determines organization attributes of an organization and/or user attributes. In one or more embodiments, the organization attributes includes information about the organization as a whole, including types of users in the organization (e.g., human resources, executives, information technology, legal, support staff, sales, or any other type of job within an organization), roles of users in the organization (e.g., handling personal information, handling financial information, control over secure systems, or any other role within an organization), an organizational list of providers (e.g., names of third-parties with whom members of the organization communicate), communication formats (e.g., phone call, email, text message, syntax of messages, lexicology used in messages, or any other details used in communicating with others either between members of the organization and/or members of the organization and third-parties), and/or user performance levels (e.g., the tested performance level of member of the organization, which is described in further detail below). In one or more embodiments, the user attributes includes information about a specific member of an organization, including the user type, role within the organization, a list of providers associated with the user, communication formats associated with the user, and/or a performance level of the user.

In Step 504, the training agent generates a simulated attack based on any combination of the attack attributes, the organization attributes, and the user attributes. In doing so, the simulated attack is based on real-world attacks and may be customized on an organization-level and even a user-level to provide accurate testing of members of the organization.

In Step 506, the training agent saves the generated simulated attack in a database (e.g., database (270), FIG. 2). Saving the generated simulated attack enables the attack to be provided at a future time to a user. In one or more embodiments, specific attack attributes, organization attributes, and/or user attributes may be associated with the saved attack so that the attack may be searched for based on the attributes.

The method may end following Step 506.

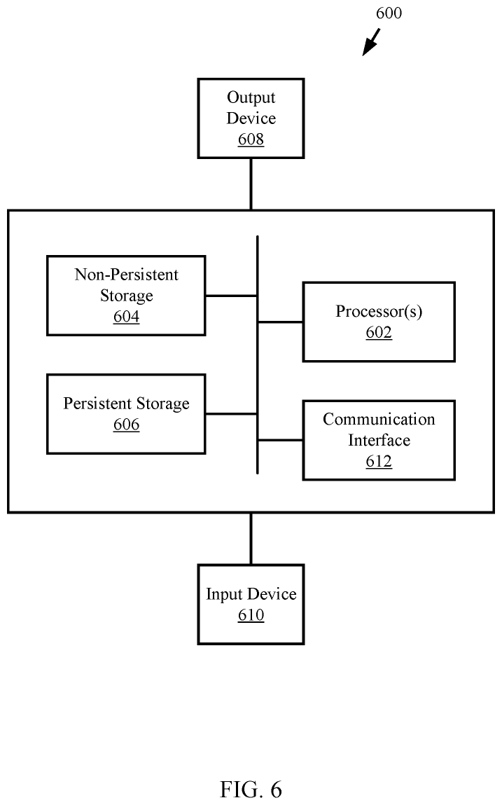

Turning now to FIG. 6, FIG. 6 shows a diagram of a computing device (600) in accordance with one or more embodiments of the scope disclosed herein.

In one or more embodiments of the invention, the computing device (600) may include one or more computer processors (602), non-persistent storage (604) (e.g., volatile memory, such as RAM, cache memory), persistent storage (606) (e.g., a hard disk, an optical drive such as a CD drive or a DVD drive, a Flash memory, etc.), a communication interface (612) (e.g., Bluetooth interface, infrared interface, network interface, optical interface, etc.), an input device(s) (610), an output device(s) (608), and numerous other elements (not shown) and functionalities. Each of these components is described below.

In one or more embodiments, the computer processor(s) (602) may be an integrated circuit for processing instructions. For example, the computer processor(s) (602) may be one or more cores or micro-cores of a processor. The computing device (600) may also include one or more input devices (610), such as a touchscreen, keyboard, mouse, microphone, touchpad, electronic pen, or any other type of input device. Further, the communication interface (612) may include an integrated circuit for connecting the computing device (600) to a network (e.g., a LAN, a WAN, Internet, mobile network, etc.) and/or to another device, such as another computing device.

In one or more embodiments, the computing device (600) may include one or more output devices (608), such as a screen (e.g., a liquid crystal display (LCD), plasma display, touchscreen, cathode ray tube (CRT) monitor, projector, or other display device), a printer, external storage, or any other output device. One or more of the output devices (608) may be the same or different from the input device(s) (610). The input and output device(s) (608, 610) may be locally or remotely connected to the computer processor(s) (602), non-persistent storage (604), and persistent storage (606). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for providing ransomware training, the method comprising:
conducting a skill assessment for a user to determine a user performance level of the user;
determining user attributes associated with the user, wherein user attributes comprise a user type, a user role, and a list of providers associated with the user;
generating a training exercise comprising a simulated attack, wherein generating the simulated attack comprises:
identifying a real-world ransomware attack;
determining attack attributes of the real-world ransomware attack, wherein the attack attributes comprise a target user type, a type of attack, and a level of attack; and
generating the simulated attack based on the attack attributes, the user attributes, and the user performance level;
conducting the training exercise by sending the simulated attack to the user;
receiving an attack response from the user, wherein the attack response comprises the user's response to the simulated attack; and
providing feedback to the user based on the attack response, the user attributes, and the user performance level.

2. The method of claim 1, further comprising:
updating the user performance level based on the user performance level and the attack response to obtain an updated user performance level;
generating a second training exercise comprising a second simulated attack, wherein generating the second simulated attack comprises:
identifying, after providing the feedback, a second real-world ransomware attack;
determining second attack attributes of the second real-world ransomware attack, wherein the second attack attributes comprise a second target user type, a second type of attack, and a second level of attack; and
generating the second simulated attack based on the second attack attributes, the second user attributes, and the updated user performance level; and
conducting the second training exercise by sending the simulated attack to the user.

3. The method of claim 1, further comprising:
conducting a second skill assessment for a second user to determine a second user performance level of the second user;
determining second user attributes associated with the second user, wherein second user attributes comprise a second user type, a second user role, and a second list of providers associated with the second user;
making a determination that a similarity between the second user attributes, the second user performance level, the user attributes, and the user performance level is above a threshold; and
conducting, based on the determination, a second training exercise by sending the simulated attack to the second user.

4. The method of claim 1, further comprising:
updating a user profile of the user by adjusting a gamification element based on the attack response, wherein the gamification element is viewable by at least one other user.

5. The method of claim 1, further comprising:
generating a summary of a performance of the user, wherein the summary comprises a progress over time of the user and an area for improvement; and
causing to display the summary to the user.

6. The method of claim 1, further comprising:
updating an organizational data based on the attack response to receive updated organizational data, wherein the organizational data comprises a summary for an organization comprising a plurality of users, wherein the user is one of the plurality of users;
determining an area of improvement for the organization based on the updated organizational data; and
causing to display the area of improvement to an administrator of the organization.

7. The method of claim 1, further comprising:
making a determination that the attack response is below a threshold value; and
causing to display, based on the determination, an alert to an administrator indicative of the attack response being below the threshold value and identifying information of the user.

8. A method for providing a ransomware training exercise, the method comprising:
identifying a real-world ransomware attack;
determining attack attributes of the real-world ransomware attack, wherein the attack attributes comprise a target user type, a type of attack, and a level of attack;
determining organization attributes of an organization, wherein the organization attributes comprise types of users, roles of users, an organizational list of providers, communication formats, or user performance levels;
generating a simulated attack based on the attack attributes and the organization attributes;
determining a plurality of sets of user attributes, wherein each set of user attributes is associated with a user of a plurality of users associated with the organization, wherein each set of user attributes comprises a user type, a user role, and a user list of providers;
selecting a portion of the plurality of users based on the simulated attack and the plurality of sets of user attributes; and
sending the simulated attack to each user of the portion of the plurality of users.

9. The method of claim 8, further comprising:
receiving a plurality of attack responses, wherein each of the plurality of attack responses are from a different user of the portion of the plurality of users; and
providing feedback to each of the portion of the plurality of users based on corresponding ones of the plurality of attack responses and the plurality of sets of user attributes.

10. The method of claim 9, further comprising:
updating a user profile of each of the portion of the plurality of users by adjusting a gamification element based on a corresponding one of the plurality of attack responses.

11. The method of claim 9, further comprising:
generating a second simulated attack by:
identifying, after providing the feedback, a second real-world ransomware attack;
determining second attack attributes of the second real-world ransomware attack, wherein the second attack attributes comprise a second target user type, a second type of attack, and a second level of attack; and
generating the second simulated attack based on the second attack attributes and the organization attributes; and
conducting a training exercise using the second simulated attack.

12. The method of claim 11, wherein conducting the training exercise comprises:
selecting a second portion of the plurality of users based on the second simulated attack and the plurality of sets of user attributes;
sending the second simulated attack to each user of the second portion of the plurality of users;
receiving a second plurality of attack responses, wherein each of the second plurality of attack responses are from a different user of the second portion of the plurality of users; and
providing second feedback to each of the second portion of the plurality of users based on corresponding ones of the second plurality of attack responses and the plurality of sets of user attributes.

13. The method of claim 9, further comprising:
updating an organizational data based on the plurality of attack responses to receive updated organizational data, wherein the organizational data comprises a summary for the organization;
determining an area of improvement for the organization based on the updated organizational data; and
causing to display the area of improvement to an administrator of the organization.

14. The method of claim 9, further comprising:
making a determination that one of the plurality of attack responses is below a threshold value; and
causing to display, based on the determination, an alert to an administrator indicative of the one of the plurality of attack responses being below the threshold value and identifying information of the user.

15. The method of claim 8, further comprising:
generating a plurality of summaries of a performance of each of the portion of the plurality of users, wherein each of the plurality of summaries comprise a progress over time and an area for improvement; and
causing to display each of the plurality of summaries to a corresponding one of the portion of the plurality of the users.

16. A non-transitory computer readable medium comprising computer readable program code, which when executed by a computer processor enables the computer processor to perform a method for providing a ransomware training exercise, the method comprising:
identifying a real-world ransomware attack;
determining attack attributes of the real-world ransomware attack, wherein the attack attributes comprise a target user type, a type of attack, and a level of attack;
determining organization attributes of an organization, wherein the organization attributes comprise types of users, roles of users, an organizational list of providers, communication formats, or user performance levels;
generating a simulated attack based on the attack attributes and the organization attributes;
determining a plurality of sets of user attributes, wherein each set of user attributes is associated with a user of a plurality of users associated with the organization, wherein each set of user attributes comprises a user type, a user role, and a user list of providers;
selecting a portion of the plurality of users based on the simulated attack and the plurality of sets of user attributes;
sending the simulated attack to each user of the portion of the plurality of users;
receiving a plurality of attack responses, wherein each of the plurality of attack responses are from a different user of the portion of the plurality of users; and
providing feedback to each of the portion of the plurality of users based on corresponding ones of the plurality of attack responses and the plurality of sets of user attributes.

17. The non-transitory computer readable medium of claim 16, wherein the method further comprises:
generating a second simulated attack by:
identifying, after providing the feedback, a second real-world ransomware attack;
determining second attack attributes of the second real-world ransomware attack, wherein the second attack attributes comprise a second target user type, a second type of attack, and a second level of attack; and
generating the second simulated attack based on the second attack attributes and the organization attributes; and
conducting a training exercise using the second simulated attack.

18. The non-transitory computer readable medium of claim 17, wherein conducting the training exercise comprises:
selecting a second portion of the plurality of users based on the second simulated attack and the plurality of sets of user attributes;
sending the second simulated attack to each user of the second portion of the plurality of users;
receiving a second plurality of attack responses, wherein each of the second plurality of attack responses are from a different user of the second portion of the plurality of users; and
providing second feedback to each of the second portion of the plurality of users based on corresponding ones of the second plurality of attack responses and the plurality of sets of user attributes.

19. The non-transitory computer readable medium of claim 16, wherein the method further comprises:
updating an organizational data based on the plurality of attack responses to receive updated organizational data, wherein the organizational data comprises a summary for the organization;
determining an area of improvement for the organization based on the updated organizational data; and
causing to display the area of improvement to an administrator of the organization.

20. The non-transitory computer readable medium of claim 16, wherein the method further comprises:
making a determination that one of the plurality of attack responses is below a threshold value; and
causing to display, based on the determination, an alert to an administrator indicative of the one of the plurality of attack responses being below the threshold value and identifying information of the user.
